(19) United States
(12) Patent Application Publication
(10) Pub. No.: US 2018/0059880 A1
(43) Pub. Date: Mar. 1, 2018

(54) METHODS AND SYSTEMS FOR INTERACTIVE THREE-DIMENSIONAL ELECTRONIC BOOK

(71) Applicant: Dimensions and Shapes, LLC, Tampa, FL (US)

(72) Inventor: Segundo Gonzalez del Rosario, Tampa, FL (US)

(73) Assignee: Dimensions and Shapes, LLC, Tampa, FL (US)

(21) Appl. No.: 15/549,846

(22) PCT Filed: Feb. 11, 2016
(86) PCT No.: PCT/US2016/017574

§ 371 Date: Aug. 9, 2017

Related U.S. Application Data
(60) Provisional application No. 62/116,827, filed on Feb. 16, 2015.
(60) Provisional application No. 62/201,056, filed on Aug. 4, 2015.

(51) Int. Cl. G06F 3/0482; G06F 3/0483

(52) U.S. Cl. CPC G06F 3/0482; G06T 19/003; G09G 2380/14; G06F 3/0483

(57) ABSTRACT

The present inventive concept relates to a system for providing an interactive three-dimensional electronic book. The system includes an input module, a processor, and an output module. The input module is configured to receive an input from a user of the interactive three-dimensional electronic book regarding an image including one or more subparts. The processor is configured to obtain the image of the one or more subparts responsive to the input from the user and relevant information pertinent to the image. The output module is configured to display the image and the relevant information.

### CROSS-REFERENCE TO RELATED PATENT APPLICATIONS

This application claims the benefit of U.S. Provisional Patent Application No. 62/116,827, titled “Methods and Systems for Interactive Three-Dimensional Electronic Book,” filed Feb. 16, 2015, and U.S. Provisional Patent Application No. 62/201,056, titled “Methods and Systems for Interactive Three-Dimensional Electronic Book,” filed Aug. 4, 2015, both of which are incorporated herein by reference in their entireties.

### BACKGROUND

The present inventive concept relates to an interactive electronic book that displays three-dimensional (3D) images responsive to user input. Current digital or electronic books lack the ability to display interactive 3D models or images, as well as a coordinated textual environment for users to read in a similar format to a traditional book. Further, the platforms on which the current electronic books operate prevent an interactive environment that allows for various user interactions with the images and/or text such as rotation, magnification, and applying transparency to different layers of the image.

### SUMMARY

One embodiment relates to a method of providing an interactive three-dimensional electronic book. The method includes receiving, by a processing circuit of an electronic device, an input from a user of the interactive three-dimensional electronic book regarding an image including one or more subparts; obtaining, by the processing circuit, the image including the one or more subparts responsive to the input from the user; obtaining, by the processing circuit, relevant information pertinent to the image; and displaying, by the processing circuit, the image and the relevant information on a display of the electronic device

Another embodiment relates to a system for providing an interactive three-dimensional electronic book. The system includes an input module, a processor, and an output module. The input module is configured to receive an input from a user of the interactive three-dimensional electronic book regarding an image including one or more subparts (e.g., any 2D or 3D interactive figure of a scientific or non-scientific topic, etc.). The processor is configured to obtain the image of the one or more subparts responsive to the input from the user and relevant information pertinent to the image. The output module is configured to display the image and the relevant information.

Still another embodiment relates to a non-transitory computer readable medium storing a computer readable program for an interactive three-dimensional electronic book. The non-transitory computer readable medium includes computer readable instructions to receive, from an electronic device, an input from a user of the interactive three-dimensional electronic book regarding an image including one or more subparts; computer readable instructions to obtain the image of the one or more subparts responsive to the input from the user; computer readable instructions to obtain relevant information pertinent to the image; and computer readable instructions to display the image and the relevant information on a display of the electronic device.

The foregoing summary is illustrative only and is not intended to be in any way limiting. In addition to the illustrative aspects, embodiments, and features described above, further aspects, embodiments, and features will become apparent by reference to the drawings and the following detailed description. Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a schematic block diagram of a computer system implementing a 3D electronic book, according to an exemplary embodiment;

FIG. 2 is a flow diagram illustrating example operations of a 3D electronic book, according to an exemplary embodiment;

FIG. 3 is an illustration of a graphical user interface of a 3D electronic book displaying a liver and other organs and structures in its vicinity, according to an exemplary embodiment;

FIG. 4A is an illustration of a graphical user interface of a 3D electronic book displaying an image in an opaque configuration, according to an exemplary embodiment;

FIG. 4B is an illustration of a graphical user interface of a 3D electronic book displaying an image in a segmented configuration, according to an exemplary embodiment;

FIG. 5 is an illustration of a graphical user interface of a 3D electronic book displaying components of an image in a transparent configuration, according to an exemplary embodiment;

FIG. 6 is an illustration of a graphical user interface of a 3D electronic book displaying components of an image in an invisible configuration, according to an exemplary embodiment;

FIG. 7 is an illustration of a graphical user interface of a 3D electronic book displaying a full-screen detailed view of an image, according to an exemplary embodiment;

FIG. 8 is an illustration of a graphical user interface of a 3D electronic book displaying a video, according to an exemplary embodiment; and

FIGS. 9A-9D are various illustrations of a graphical user interface of a 3D electronic book displaying an image in a 2D3D configuration, according to an exemplary embodiment.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring to the Figures generally, various embodiments disclosed herein relate to an interactive three-dimensional (3D) electronic book capable of providing images based on a user input. The interactive 3D electronic book may be installed on user devices, such as a personal computer, a tablet, a smartphone, and the like. The user input may include, but not limited to, keyword inputs, mouse clicks, screen touches, mouse motions, and device motions (e.g., tilting and/or rotating a tablet or smartphone, etc.). The 3D electronic book displays the images responsive to the user input and also displays corresponding labels and texts.

The images may include 2D, 3D, and/or 2D3D anatomical images of human body parts or any 2D, 3D, and/or 2D3D interactive figure or image of a scientific topic (e.g., medical, engineering, etc.) or non-scientific topic (e.g., sports, travel, culinary arts, automotive, etc.). Traditional images in electronic books are opaque, thus unable to show subparts that are layered behind an opaque subpart of the image. The platform of the exemplary electronic book (e.g., a gaming platform, etc.) allows for this freedom of interaction, providing an interactive mechanism that enables users to see transparent 3D images showing various layers of subparts, as well as the ability of 360 degree rotation and zoom in/out of the image or model. All these interactions may be linked with informative text. This may enable users of the electronic book to have a realistic and interactive experience, which may be particularly useful in training students (e.g., medical students, engineering students, etc.), nurses, doctors, etc. The electronic book of the present disclosure may provide the benefit of the fusion of the interactive freedom of current gaming technology with the clarity and organization of traditional textbooks and other learning platforms to raise the level of learning and visualization for the next generation of students. In some embodiments, the electronic book allows for the integration to current media modalities within the informative text, including, but not limited to Internet searches, video streaming, as well as web browsing. This may facilitate and unite all current modalities for learning, in a single platform.

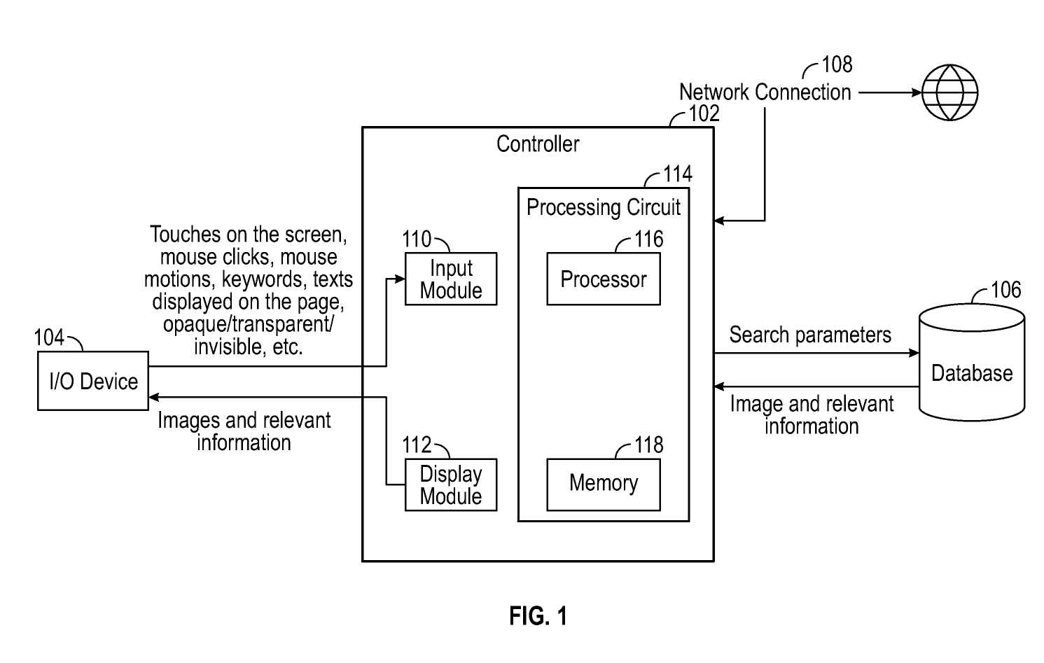

As shown in FIG. 1, an exemplary implementation of a computer system 100 of the interactive 3D interactive electronic book includes a controller 102, an input/output (I/O) device 104, a database 106, and a network connection 108 connecting the controller 102 to the Internet.

The controller 102 manages and processes inputs and outputs of the computer system 100 of the 3D interactive electronic book. The controller 102 further includes an input module 110, a display module 112, and a processing circuit 114 including a processor 116 and memory 118. In some embodiments, the controller 102 is implemented on a gaming platform to enable fast image processing and rendering.

The I/O device 104 may be any device capable of capturing user input and displaying images. I/O device 104 may be devices including, but not limited to, personal computers, mobile phones, and electronic tablets. For example, I/O device 104 may be an iPhone, an iPad, mobile phones or tablets running Android, etc. For another example, I/O device 104 may be an Amazon FIRE tablet. In some embodiments, I/O device 104 may be a device with a touch sensitive screen.

Referring to the various components of the controller 102, the input module 110 is configured to receive input from the I/O device 104 such that a user interacts with the 3D electronic book. The input from I/O device 104 may include, but not limited to, keyboard inputs, mouse clicks, screen touches from the user of the I/O device 104, voice commands, and/or still other inputs. In one embodiment, the I/O device 104 includes a keyboard. By way of example, the user may enter a search keyword of a human organ or structure, such as “liver” or “stomach”, and the input module 110 is configured to receive the search keyword. In another embodiment, the I/O device 104 includes a mouse or a touchpad. The input module 110 is configured to receive touch inputs such as the user rotating and/or magnifying the images being displayed by dragging the image using fingers. In still another embodiment, the input module 110 is configured to receive user clicks on an icon besides a term or a phrase of an organ or structure. In an alternate embodiment, input module 110 is configured to receive user choices of displaying the image of the organ or structure as opaque, transparent, or invisible. In further embodiments, input module 110 is configured to receive texts that are displayed on the screen of the I/O device 104 as the user input.

As shown in FIG. 1, processing circuit 114 includes processor 116 and memory 118. Processing circuit 114 processes the user input, communicates with the database 106 if needed and sends the images and relevant information to the display module 112.

Processor 116 may be implemented as a general-purpose processor, an application specific integrated circuit (ASIC), one or more field programmable gate arrays (FPGAs), a digital-signal-processor (DSP), a group of processing components, or other suitable electronic processing components. Memory 118 is one or more devices (e.g., RAM, ROM, Flash Memory, hard disk storage, etc.) for storing data and/or computer code for facilitating the various processes described herein. Memory 118 may be or include non-transient volatile memory or non-volatile memory. Memory 118 may include database components, object code components, script components, or any other type of information structure for supporting the various activities and information structures described herein. Memory 118 may be communicably connected to processor 116 and provide computer code or instructions to processor 116 for executing the processes described herein.

Referring still to FIG. 1, the database 106 may store two-dimensional (2D) images, 3D images, and/or 2D3D images (e.g., an anatomical image of human organs and structures, etc.) and other meta data about the images. In one embodiment, the meta data include description of images, such as names of organs or structures and index files to facilitate image searches. In various embodiments, the images may be in various formats, including, but not limited to, jpeg, png, etc. In one embodiment, the image is a computer rendered image. In another embodiment, the image is an actual image (e.g., a digital picture taken with a camera, etc.). In some embodiments, the database 106 stores animations and/or videos. Also in various embodiments, the database that stores the images and/or videos may be a commercial off-the-shelf product, such as Microsoft SQL server, Oracle database, or open source software, such as MySQL, or other customized software that is implemented specifically for the 3D electronic book. In one embodiment, the database is embedded. Based on the user input, relevant images and/or videos stored in the database 106 may be retrieved and sent to the display module 112. Additionally or alternatively, the images and/or videos may be received from the Internet (e.g., YouTube®, etc.) via the network connection 108. For example, the processing circuit 114 may be configured to coordinate and provide access to multiple media modalities that may include Internet searches, web browsing, and/or video streaming, among other possibilities.

Referring still to FIG. 1, the display module 112 displays images/videos and relevant information responsive to the user input. In one embodiment, the new images are different organs or structures than what were displayed, and the new images are retrieved from the database 106. In another embodiment, the new images are rendered based on the differences of the new image and the previously displayed image, for example, if certain organs or structures are to become invisible or partially transparent. In an alternative embodiment, corresponding texts and labels are also displayed. In further embodiments, the display module 112 is adaptive to the I/O device 104 and renders text, images, animations, and/or videos accordingly (e.g., color, size, resolution, etc.) depending on, for example, whether the I/O device 104 is a computer, a tablet, or a smartphone. In still further embodiments, the display module 112 is adaptive to the I/O device 104 and renders the text, images, and/or videos based on the orientation of the I/O device 104 (e.g., a landscape display, a portrait display, etc.).

Referring still to FIG. 1, the controller 102 is connected to the Internet by the network connection 108. The network connection 108 may be wired or wireless (e.g., Bluetooth, WIFI, etc.) connections.

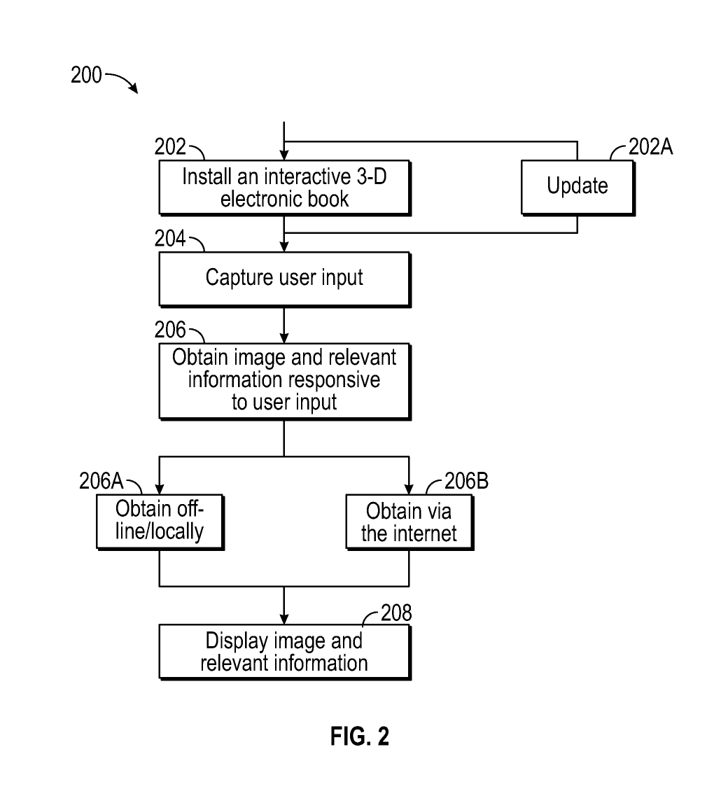

Now referring to FIG. 2, a flow diagram illustrating example operations for the 3D electronic book is shown, according to an exemplary embodiment. At step 202, the interactive 3D electronic book is installed on a user device. In various embodiments, the 3D electronic book is downloaded as, for example, executables, zip files, etc. In one embodiment, different versions of the interactive 3D electronic books are provided for various user devices, for example, a specific version will be provided to iPhone users. In another embodiment, at step 202A, the interactive 3D electronic book will be updated, with an updated database storing updated collection of images and with updated software components. The update step may be invoked regularly by the 3D electronic book and the software, for example, every 1 to 2 months. The update step may be invoked by the user manually by clicking, for example, an update option. In an alternative embodiment, the database storing images are downloaded locally to the user's device (e.g., an off-line database, etc.).

At step 204, the interactive 3D electronic book has been installed and is now ready for use. At step 204, the input module 110 captures the user input and sends the user input to the processing circuit 114 for processing. In some embodiments, as described above, the user input can be keywords, mouse clicks, touches of the screen of the user devices, voice commands, etc.

At step 206, once the user input is received by the processor 116, the processor 116 acquires information responsive to the user input. The processor 116 determines if the information may be retrieved locally (shown as step 206A), or via the Internet (shown as step 206B). In some embodiments, other relevant information, such as labels and corresponding explanatory texts, are retrieved. In one embodiment, images, text, animations, and/or videos are retrieved from the off-line database 106. In another embodiment, the user input is to search online, and thus the information is retrieved from the Internet via network connection 108. In further embodiments, no new images are retrieved as the processor 116 calculates the differences of the new image and the previously displayed images.

At step 208, in one embodiment, the image, animation, video, text, and/or other information responsive to user input is rendered by the display module 112 and provided to the I/O device 104. As described above, in some embodiments, the display module 112 adapts to the I/O device 104 (e.g., size, font, resolution, orientation, etc.) and renders the images and other information accordingly.

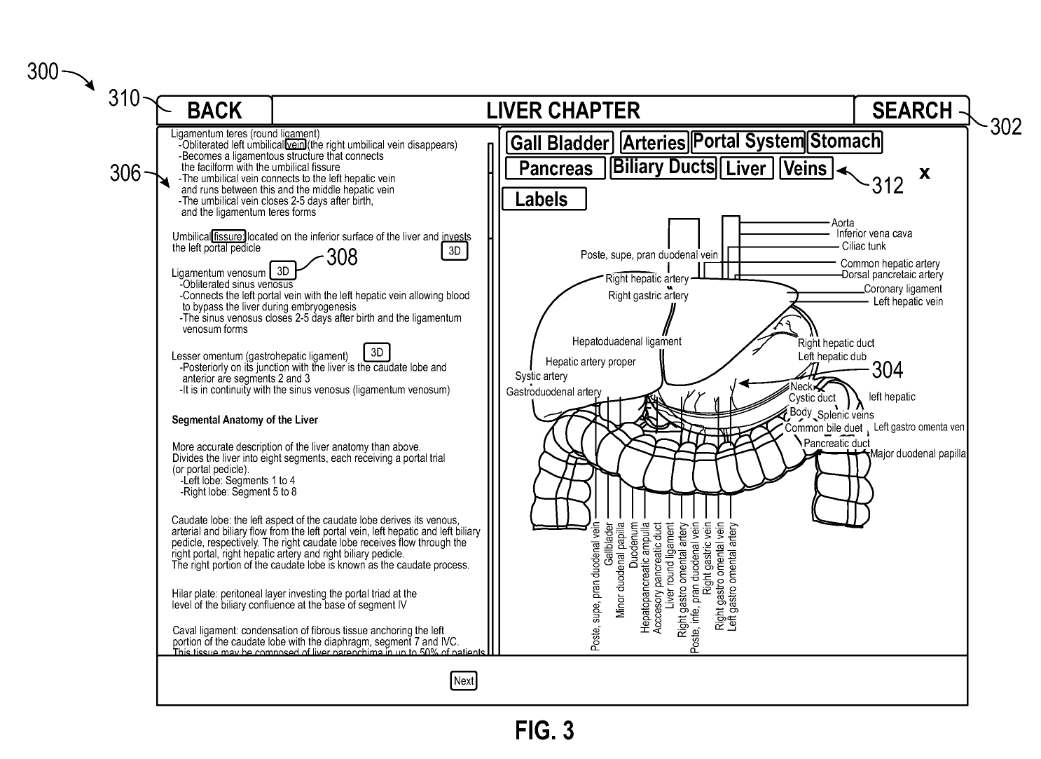

According to the exemplary embodiment shown in FIGS. 3-9D, the display module 112 displays various information, images (e.g., 2D images, 3D images, 2D3D images, etc.), videos, animation, text, and the like to a user of the interactive 3D electronic book via a graphical user interface (GUI) on the I/O device 104 (e.g., configured in a landscape orientation, etc.). In one embodiment, the GUI is automatically provided to the I/O device 104 in the landscape orientation. In another embodiment, the GUI is provided to the I/O device 104 in the landscape orientation responsive to the I/O device 104, such as a smartphone or tablet, being rotated from a portrait orientation to a landscaped orientation. In some embodiments, the GUI is provided to the I/O device 104 in the portrait orientation responsive to the I/O device 104 being held in a portrait orientation. In some embodiments, the display module 112 adjusts and/or resizes text, images, animations, and/or videos displayed within windows of the GUI based on the amount, size, and/or content of the text, images, animations, and/or videos and/or based on the orientation of the I/O device 104 (e.g., portrait versus landscape, etc.). For example, the display module 112 may adjust the font size of a text passage and/or the size of an image to fit the text passage and/or the image within a corresponding window of the GUI.

Traditionally, when using form factor devices, such as a smartphone or tablet, electronic books are displayed in a portrait orientation. If a user selects an image, then the user is directed to another or subsequent page or window to see the selected image. This frequently leads to the user having to flip back and forth between pages or windows to see text corresponding with the image. According to an exemplary embodiment, an image, a video, and/or an animation and corresponding text are able to be displayed simultaneously on the I/O device 104 by providing the GUI in the landscape orientation. For example, the text may be displayed on a left hand side of the GUI and the image or video may be displayed on the right hand side of the GUI.

Referring now to FIG. 3, a GUI 300 of the 3D electronic book displaying an anatomical image 304 including various organs and structures is shown, according to an exemplary embodiment. In one embodiment, the user enters a search keyword in the search box 302 to return various images and text corresponding to the search. In this example, the user enters the keyword “liver.” In response to the search on “liver,” the GUI 300 of the 3D electronic book displays a page whereby a 3D anatomical image 304 of the liver and others organs in its vicinity are displayed, including for example, the gallbladder, the stomach, and the intestine. In one embodiment, different organs, segments of organs, and/or structures are colored, shaded, numbered, or filled differently for easy identification. Further the anatomical image 304 is also labeled, identifying various parts, such as, for this example, “Colon”, “Aorta”, etc. As shown in FIG. 3, the anatomical image 304 is displayed on the right side of the page, and corresponding texts that explain the anatomical image 304, shown by text section 306, are displayed on the left side of the page of the GUI 300. By way of example, the text section 306 “SEGMENTAL ANATOMY OF THE LIVER” explains the anatomy of the liver. Also by way of example, when an image corresponding to a term or phrase is available, a “3D” icon appears beside the term or phrase. For this example, a “3D” icon 308 appears beside “Ligamentum venosum.” When the user clicks on the “3D” icon 308, the image of “Ligamentum venosum” may be displayed on the right side of the page of the GUI 300. In some embodiments, the “BACK” button 310 enables the user to go back to a previous page, access a book menu, or the like, allowing navigation through different pages, interfaces, etc. similar to a real experience of flipping pages of a book.

In an alternative embodiment, the images are displayed responsive to the texts that are displayed on the page in the text section 306. For example, as the user scrolls down along the left side of the page or changes to a subsequent page, different subparts of the anatomical image 304 may be highlighted, displayed, hidden, or the like based on the displayed text in the text section 306. For example, if the texts on the page describe the lobes of the liver, then the lobes of the liver on the image may be featured (e.g., highlighted, magnified, etc.).

In further embodiments, the GUI 300 includes various buttons 312 that correspond to respective organs or structures that are included in the anatomical image 304. For this example, “Gall Bladder,” “Stomach,” “liver,” etc. are listed. When the user clicks on a button 312 that is displayed by the GUI 300, an image including only that organ or structure and other body parts layered behind that organ or structure may be shown, which is discussed in greater detail below.

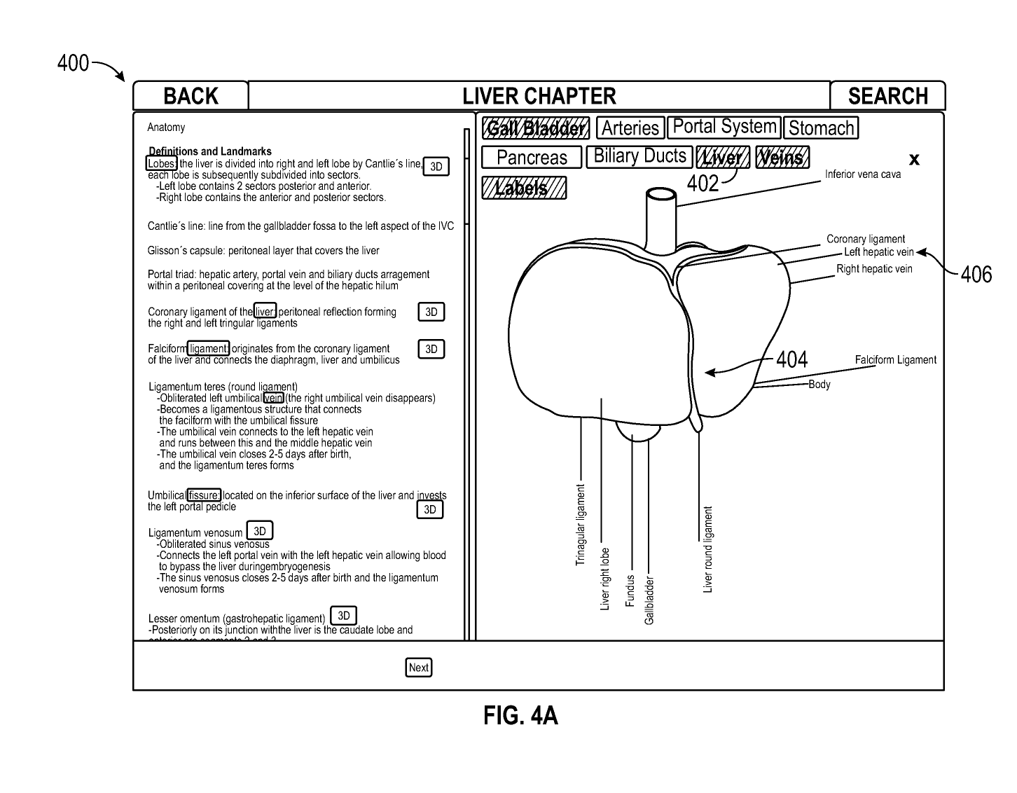

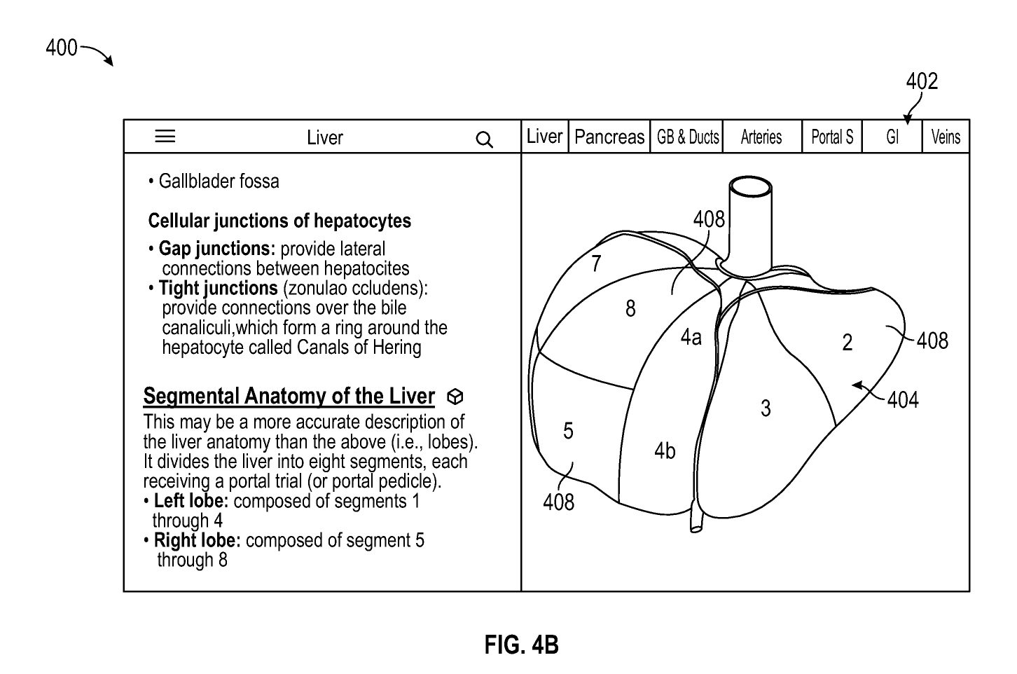

Now referring to FIG. 4A, a GUI 400 of the 3D electronic book displaying an anatomical image 404 of a liver in an opaque configuration and with rotation is shown, according to an exemplary embodiment. In one embodiment, after the user clicks on the “Liver” button 402, the anatomical image 404 image is refreshed, displaying only the liver organ and other organs or structures that are layered behind the liver. For this example, the gallbladder and interior vena cava that are layered behind the liver are included in the anatomical image 404. In another embodiment, by default, the organ near the front is opaque, occluding other organs or structure behind it. For this example, the liver of the anatomical image 404 is opaque. Labels 406 identify the various subparts of the anatomical image 404, such as left hepatic vein of the liver. In some embodiments, the labels 406 may be hidden in a similar manner as the anatomical image 404 described herein. According to one embodiment, the anatomical image 404 can be rotated. For this example, compared to that in FIG. 3, the anatomical image 404 of the liver has been rotated counter-clockwise. The rotation may be achieved through, for example, a mouse motion of moving one point on the anatomical image 404 or a touch input. For another example, the anatomical image 404 may be rotated via menu options. As described in detail below, if the user continues to operate on the buttons 402 of the GUI 400, the body part corresponding to the button will become transparent or invisible.

Referring now to FIG. 4B, the GUI 400 of the electronic book may additionally or alternatively display an image in a segmented number configuration. As shown in FIG. 4B, the anatomical image 404 includes a plurality of subcomponents, shown as segments 408. According to an exemplary embodiment, the segments 408 of the anatomical image 404 identify various portions of the anatomical image 404. For example, the segments 408 may be used to identify and distinguish the right lobe of the liver from the left lobe of the liver.

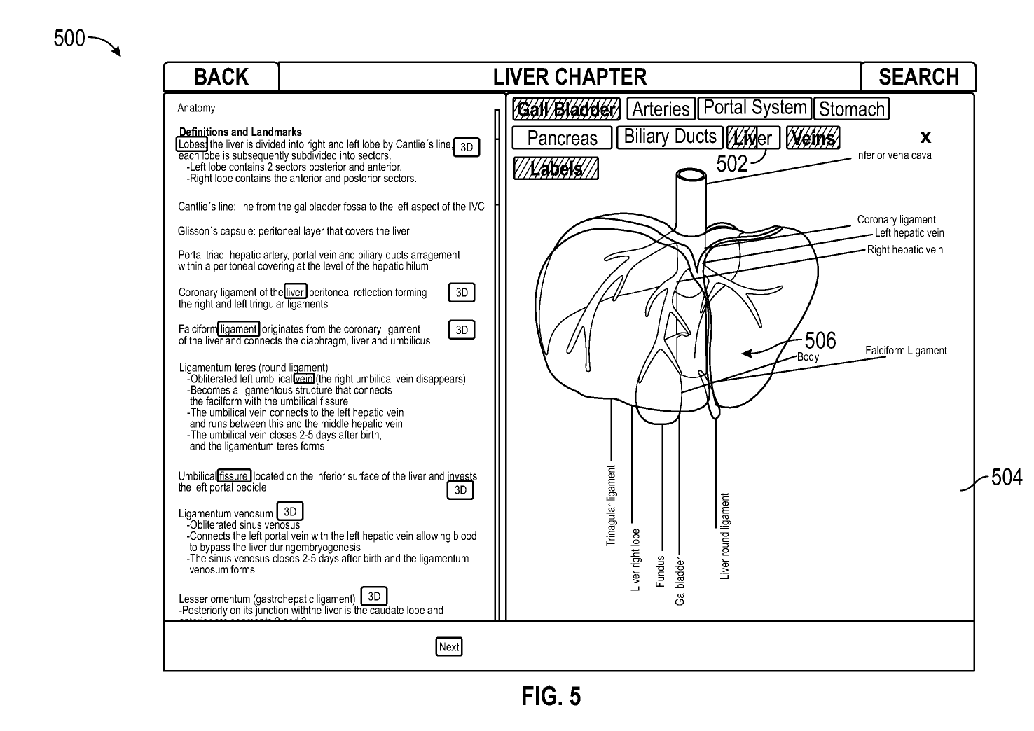

Referring now to FIG. 5, a GUI 500 of the 3D electronic book displaying an anatomical image 506 of a liver in a transparent configuration is shown, according to an exemplary embodiment. For this particular example, half of the “Liver” button 502 is not highlighted, blending with the background color of the image canvas 504. In other words, half of the button 502 blends in with the background color of the image canvas 504 and is see-through. The other half of the button shows the original color of the button (e.g., blue, etc.). As shown by the anatomical image 506, this is an exemplary indication that the liver displayed in the anatomical image 506 is at least partially transparent. The inferior vena cava and the gallbladder that are layered behind the liver now become visible in the anatomical image 506. In one embodiment, the user slides a vertical bar in the button 502 in a horizontal motion, enlarging or shrinking the portion of the button that is see-through corresponding to an amount that the liver in the anatomical image 506 is transparent (e.g., 100% opaque, 50% transparent/opaque, invisible, etc.). In another embodiment, the user clicks on the button (e.g., using a mouse, using touch, etc.), and the button will be opaque with original color of the button, half see-through and half-opaque, or completely see-through corresponding with the transparency of the associated portion of the anatomical image 506.

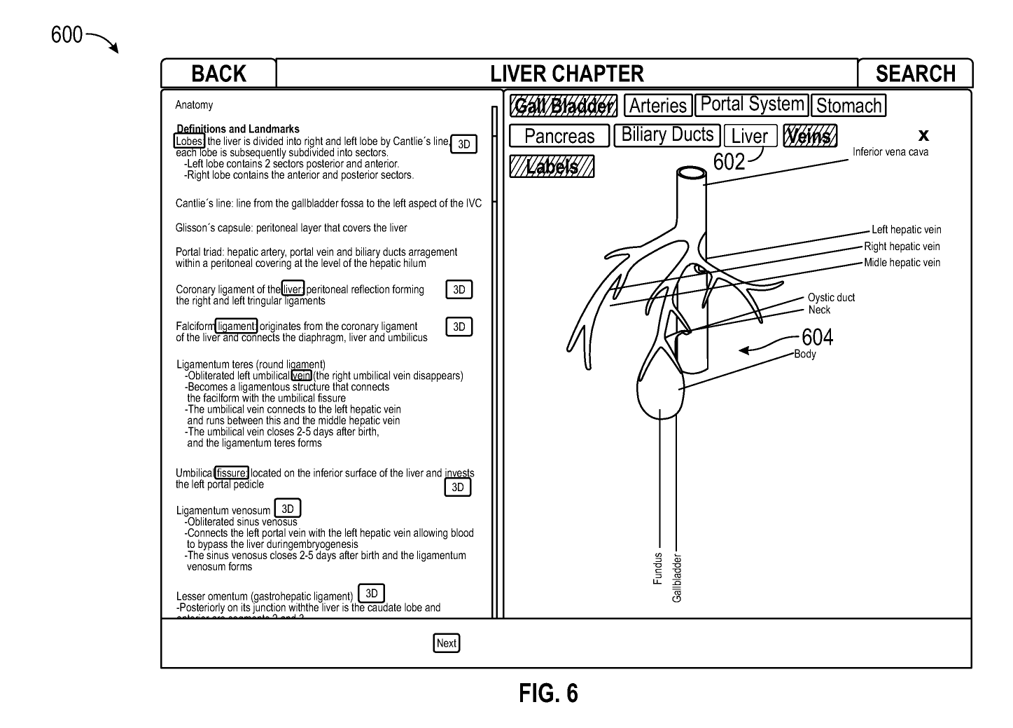

Referring to FIG. 6, a GUI 600 of the 3D electronic book displaying components of an anatomical image 604 (e.g., a liver, etc.) in an invisible configuration is shown, according to an exemplary embodiment. For this particular example, as shown by the “Liver” button 602, the button blends in with the image canvas and is completely see-through. This is an exemplary indication that the liver is now invisible on the anatomical image 604. As shown by the anatomical image 604, the only organs shown on the image canvas are those that are layered behind the liver, such as the gallbladder and the inferior vena cava.

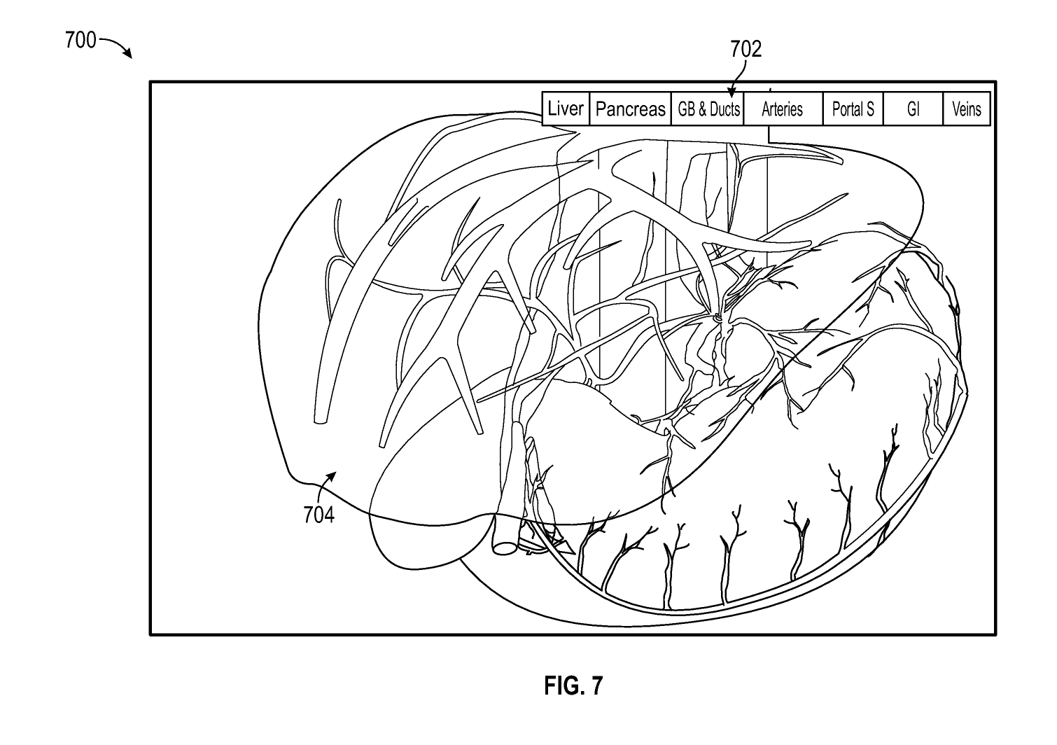

Referring now to FIG. 7, an anatomical image 704 (or video) may be displayed on a GUI 700 in a full screen landscape orientation, according to an exemplary embodiment. For example, a user of the 3D electronic book may select to zoom in on the anatomical image 704 or hide corresponding text related to the anatomical image 704. According to an exemplary embodiment, the GUI 700 includes buttons 702 that correspond to respective organs or structures that are included in the full screen anatomical image 704. For example, the buttons 702 include “Liver,” “Pancreas”, etc. When the user clicks on a button 702 that is displayed above the anatomical image 704, an organ corresponding with the button may be hidden or become partially transparent (e.g., one click the organ becomes transparent, two clicks the organ becomes hidden, etc.).

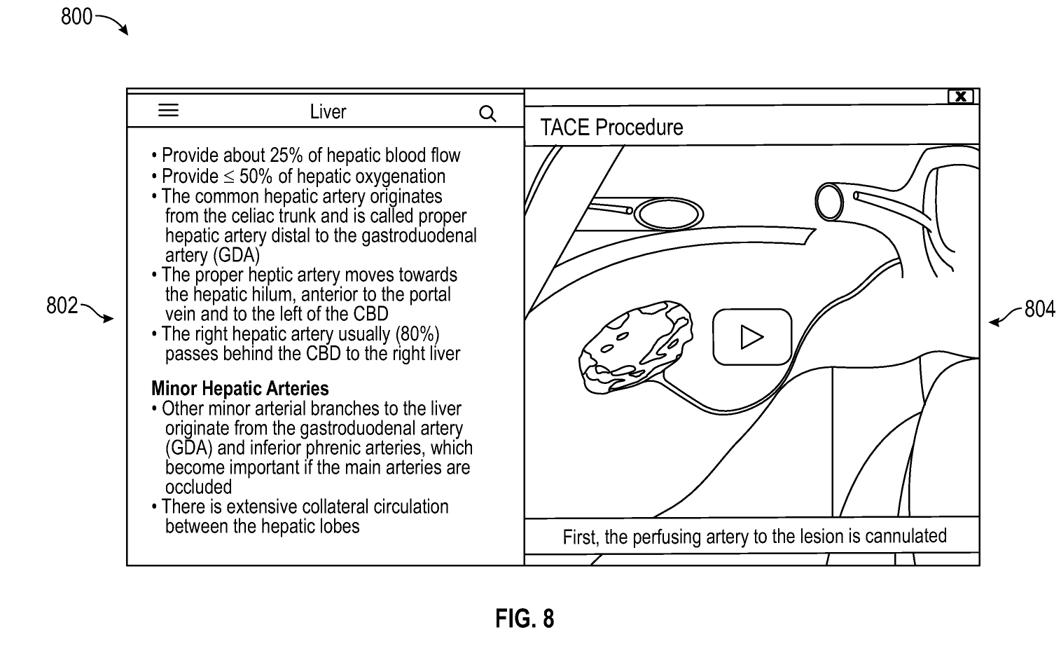

Referring to FIG. 8, a video 804 (or animation) is displayed alongside a corresponding text section 802 on a GUI 800 in a landscape orientation. In one embodiment, the video 804 may appear in response to a user of the 3D electronic book selecting a hyperlink within the text section 802. In another embodiment, the video 804 appears in response to a user search (e.g., via YouTube®, etc.) within a search section of the text section 802. In yet another embodiment, the video 804 may appear in response to a user scrolling through a certain section of the text section 802 or flipping to a certain page within the text section 802. According to an exemplary embodiment, the controller 102 correctly places and sizes the video 804 on the corresponding half of the screen of the I/O device 104 (e.g., on the right side of the screen, etc.) based on various characteristics of the I/O device 104 and the video 804 (e.g., size of the screen, resolution, etc.). In some embodiments, the video 804 automatically expands to cover the entire GUI 800 in response to the user selecting to play the video 804 (e.g., this feature may be suppressed in predefined settings, etc.). In other embodiments, the video 804 manually expands to cover the entire GUI 800 in response to a user command or expansion selection.

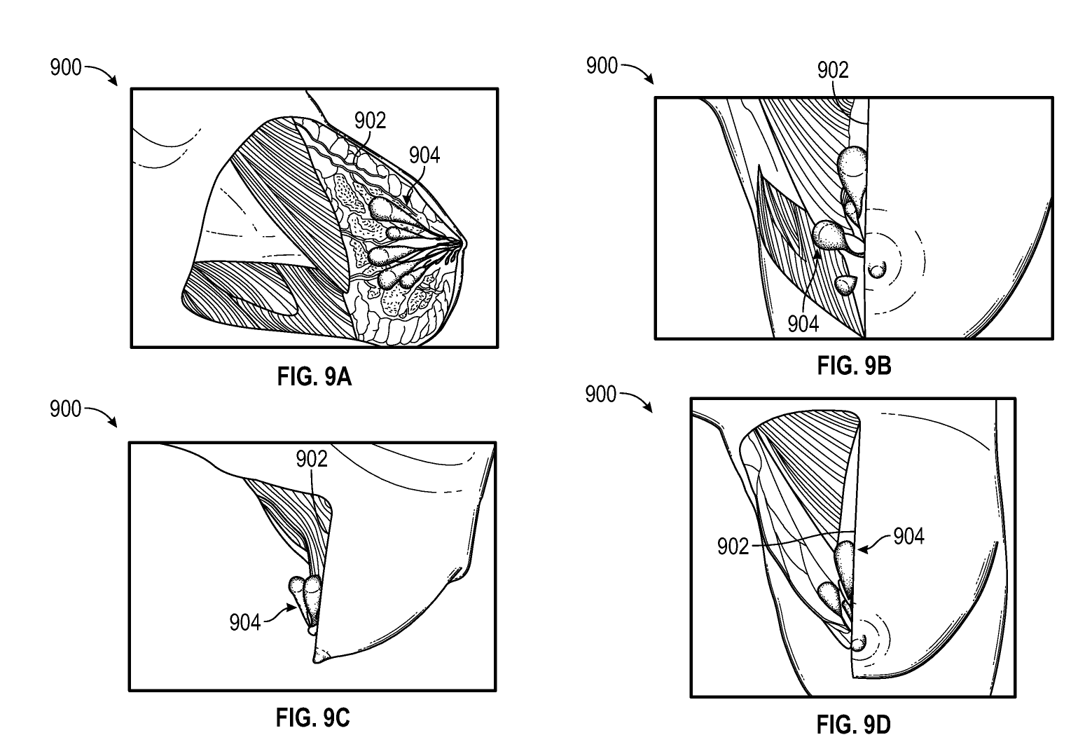

According to the exemplary embodiments shown in FIGS. 9A-9D, 2D3D anatomical images 900 may be generated by the controller 102 for display on the I/O device 104. As shown in FIGS. 9A-9D, the 2D3D anatomical images 900 include a 2D portion 902 and a 3D portion 904. The 2D portion 902 of the 2D3D anatomical images 900 is a cut through (e.g., creating a 2D plane, cross-section, etc.) of the 2D3D anatomical image 900 and the 3D portion 904 of the 2D3D anatomical images 900 protrudes (e.g., extrudes, extends, etc.) from the 2D portion 902. The 3D portion 904 may be anatomical structures such as vessels, veins, lobes, ducts, or other components of a particular organ (e.g., a breast, a liver, a heart, etc.). The 3D portion 904 may be interactive such that the transparency of the components of the 3D portion 904 is able to be adjusted (e.g., from opaque to invisible, etc.). The 3D portion 904 may also become animated such that the 3D portion 904 itself may be rendered into a 2D and/or a 2D3D image. As shown in FIGS. 9A-9D, a 2D3D anatomical image 900 of a breast has been cut, providing a 2D surface (e.g., a plane, etc.) representing the 2D portion 902 (e.g., background, etc.) of the 2D3D anatomical image 900. The inner structures (e.g., lobes, ducts, etc.) of the 2D3D anatomical image 900 (e.g., breast, etc.) represent the 3D portion 904 of the 2D3D anatomical image 900, providing a 3D view that clearly distinguishes the components of the 3D portion 904 from the 2D portion 902. According to an exemplary embodiment, the 2D3D anatomical image 900 as a whole remains 3D such that it may be rotated and/or otherwise manipulated (e.g., cropped, magnified, transparency modifications, etc.), as shown in FIGS. 9A-9D and as described above.

According to an exemplary embodiment, the 3D electronic book is compatible with and optimized to interact with other external software platforms such as social media (e.g., Facebook®, Twitter®, etc.). This may allow a unique interaction and visualization upon exporting or importing information to and away from the 3D electronic book.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

It should be noted that the term “example” and “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The schematic flow chart diagrams and method schematic diagrams described above are generally set forth as logical flow chart diagrams. As such, the depicted order and labeled steps are indicative of representative embodiments. Other steps, orderings and methods may be conceived that are equivalent in function, logic, or effect to one or more steps, or portions thereof, of the methods illustrated in the schematic diagrams.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method of providing an interactive three-dimensional electronic book, comprising:
receiving, by a processing circuit of an electronic device, an input from a user of the interactive three-dimensional electronic book regarding an image including one or more subparts;
obtaining, by the processing circuit, the image including the one or more subparts responsive to the input from the user;
obtaining, by the processing circuit, relevant information pertinent to the image; and
displaying, by the processing circuit, the image and the relevant information on a display of the electronic device.

2. The method of claim 1, wherein the image includes at least one of a computer rendering and an actual image.

3. The method of claim 1, wherein the image and the relevant information are at least one of retrieved from a local database of the interactive three-dimensional electronic book and downloaded from the Internet.

4. The method of claim 1, further comprising making, by the processing circuit, a subpart of the one or more subparts of the image at least one of opaque, transparent, and invisible based on the input.

5. The method of claim 4, further comprising making, by the processing circuit, the one or more subparts included in the image that are layered behind the subpart visible in the image in response to the subpart being made transparent or invisible.

6. The method of claim 4, wherein the subpart of the image includes an image of a human body part.

7. The method of claim 1, wherein the input comprises texts that are displayed on the display of the electronic device, and the image and the relevant information are responsive to the texts.

8. The method of claim 1, wherein the relevant information and the image are displayed side-by-side in a landscape configuration.

9. The method of claim 1, wherein the image includes a two-dimensional portion and a three-dimensional portion, wherein the three-dimensional portion extends from the two-dimensional portion creating a 2D3D image.

10. The method of claim 1, wherein the image includes at least one of a two-dimensional image, a three-dimensional image, a 2D3D image, an animation, and a video.

11. A system for providing an interactive three-dimensional electronic book, comprising:
an input module configured to receive an input from a user of the interactive three-dimensional electronic book regarding an image including one or more subparts;
a processor configured to obtain the image of the one or more subparts responsive to the input from the user and relevant information pertinent to the image; and
an output module configured to display the image and the relevant information.

12. The system of claim 11, wherein the image includes at least one of a computer rendering, a picture, a two-dimensional image, a three-dimensional image, a 2D3D image, an animation, and a video.

13. The system of claim 11, wherein the image and the relevant information are at least one of retrieved from a local database of the interactive three-dimensional electronic book and downloaded from the Internet.

14. The system of claim 11, wherein the processor is configured to make a subpart of the image at least one of opaque, transparent, and invisible based on the input.

15. The system of claim 14, wherein the processor is configured to make the one or subparts included in the image that are layered behind the subpart visible in the image in response to the subpart being made transparent or invisible.

16. The system of claim 11, wherein the input comprises texts that are displayed on the display of the electronic device, and the image and the relevant information are responsive to the texts.

17. The system of claim 11, wherein the relevant information and the image are displayed side-by-side in a landscape configuration.

18. The system of claim 11, wherein the image includes a two-dimensional portion and a three-dimensional portion, wherein the three-dimensional portion extends from the two-dimensional portion creating a 2D3D image.

19. The system of claim 11, wherein the processor is configured to coordinate and provide access to a media modality including at least one of Internet searches, web browsing, and video streaming.

20. A non-transitory computer readable medium storing a computer readable program for an interactive three-dimensional electronic book, comprising:
computer readable instructions to receive, from an electronic device, an input from a user of the interactive three-dimensional electronic book regarding an image including one or more subparts;
computer readable instructions to obtain the image of the one or more subparts responsive to the input from the user;
computer readable instructions to obtain relevant information pertinent to the image; and
computer readable instructions to display the image and the relevant information on a display of the electronic device.
